(19) United States
(12) Patent Application Publication
(10) Pub. No.: US 2015/0327142 A1
(43) Pub. Date: Nov. 12, 2015

(54) APPARATUS, COMPUTER-READABLE MEDIUM, AND METHOD TO SUPPORT LOW COMPLEXITY USER EQUIPMENT

(71) Applicants: Marta Martinez Tarradell, Hillsboro, OR (US); Richard C. Burbidge, Shrivenham (GB); Youn Hyoung Heo, San Jose, CA (US); Alexander Sirotkin, Tel-Aviv (IL); Ana Lucia Pinheiro, Hillsboro, OR (US); Puneet Jain, Hillsboro, OR (US); Candy Yiu, Portland, OR (US); Sangeetha L. Bangolae, Beaverton, OR (US); Hyung-Nam Choi, Hamburg (DE)

(72) Inventors: Marta Martinez Tarradell, Hillsboro, OR (US); Richard C. Burbidge, Shrivenham (GB); Youn Hyoung Heo, San Jose, CA (US); Alexander Sirotkin, Tel-Aviv (IL); Ana Lucia Pinheiro, Hillsboro, OR (US); Puneet Jain, Hillsboro, OR (US); Candy Yiu, Portland, OR (US); Sangeetha L. Bangolae, Beaverton, OR (US); Hyung-Nam Choi, Hamburg (DE)

(21) Appl. No.: 14/670,729

(22) Filed: Mar. 27, 2015

Related U.S. Application Data
(60) Provisional application No. 61/990,685, filed on May 8, 2014.

(51) Int. Cl. H04W 36/24; H04W 24/10

(52) U.S. Cl. CPC H04W 36/24; H04W 24/10

(57) ABSTRACT

Apparatus, computer-readable medium, and method to support low complexity user equipment are disclosed. A wireless communication device including circuitry is disclosed. The circuitry may be configured to determine support of a target evolved nodeB (eNB) for a low complexity user equipment (LC-UE), and handover the LC-UE to the target eNB if the support of the target eNB indicates the target eNB supports LC-UE. The wireless communication device may be a long term evolution (LTE) wireless communication device. The wireless communication device may be one of the following a source eNB, a core network entity, a LC-UE, a source radio network controller (RNC), a base station, a source base service set (BSS). The circuitry may be configured to determine support of the target eNB for the LC-UE based on a configuration or information from the target eNB.

### PRIORITY CLAIM

This application claims the benefit of priority under 35 USC 119(e) to U.S. Provisional Patent Application Ser. No. 61/990,685, filed May 8, 2014, which is incorporated herein by reference in its entirety.

### TECHNICAL FIELD

Embodiments pertain to wireless communications. Some embodiments relate to communicating user equipment category support. Some embodiments relate to 3GPP networks including Long-Term Evolution (LTE) and LTE advanced (LTE-A) networks. Some embodiments relate to communicating user equipment category support to determine suitability for handover to a target node.

### BACKGROUND

Machine-Type Communications (MTC) such as Machine-to-Machine (M2M) communications may refer to data communications between machines which may be over mobile networks. Examples of MTC applications include fleet management, remote maintenance and control, and remote diagnoses. User equipment for MTC may be of lower complexity than other user equipment, and there may be more of the lower complexity user equipment. The user equipment may be termed low complexity user equipment, however, in some cases the user equipment may be of a same or higher complexity.

The wireless medium is limited and efficient use of the wireless medium may provide greater bandwidth for user equipment and quicker response times. Thus, there are general needs for improved handling of low complexity user equipment.

### BRIEF DESCRIPTION OF THE DRAWINGS

FIG. 1 shows a portion of an end-to-end network architecture of an Long-Term Evolution (LTE) network with various components of the network in accordance with some embodiments;

FIG. 2 illustrates an evolved NodeB (eNB) with information regarding low-complexity user equipment (LC-UE) support in accordance with some embodiments;

FIG. 3 illustrates a method of an eNB querying a database for other eNB LC-UE support in accordance with some embodiments;

FIG. 4 illustrates a method of determining support for LC-UEs where messages are exchanged in accordance with some embodiments;

FIG. 5 illustrates a method of determining support for LC-UEs where an eNB requests LC-UE support information from another eNB in accordance with some embodiments;

FIG. 6 illustrates a method of determining support for LC-UEs where an eNB indicates support information for LC-UEs in accordance with some embodiments;

FIG. 7 illustrates a method of determining support for LC-UEs where an eNB requests LC-UE support information from another eNB in accordance with some embodiments;

FIG. 8 illustrates a method of determining support for LC-UEs where an eNB requests LC-UE support information from another eNB in accordance with some embodiments;

FIG. 9 illustrates a method of determining support for LC-UEs in accordance with some embodiments;

FIG. 10 illustrates a method of determining support for LC-UEs in accordance with some embodiments;

FIG. 11 illustrates a method of determining whether to handover a LC-UE to a destination eNB in accordance with some embodiments;

FIG. 12 illustrates a method of an inter-RAT handover of a LC-UE to a target eNB in accordance with some embodiments;

FIG. 13 illustrates a method of an inter-RAT handover of a LC-UE to a target eNB in accordance with some embodiments;

FIG. 14 shows a block diagram of a LC-UE in accordance with some embodiments; and

FIG. 15 shows a block diagram of an eNB in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

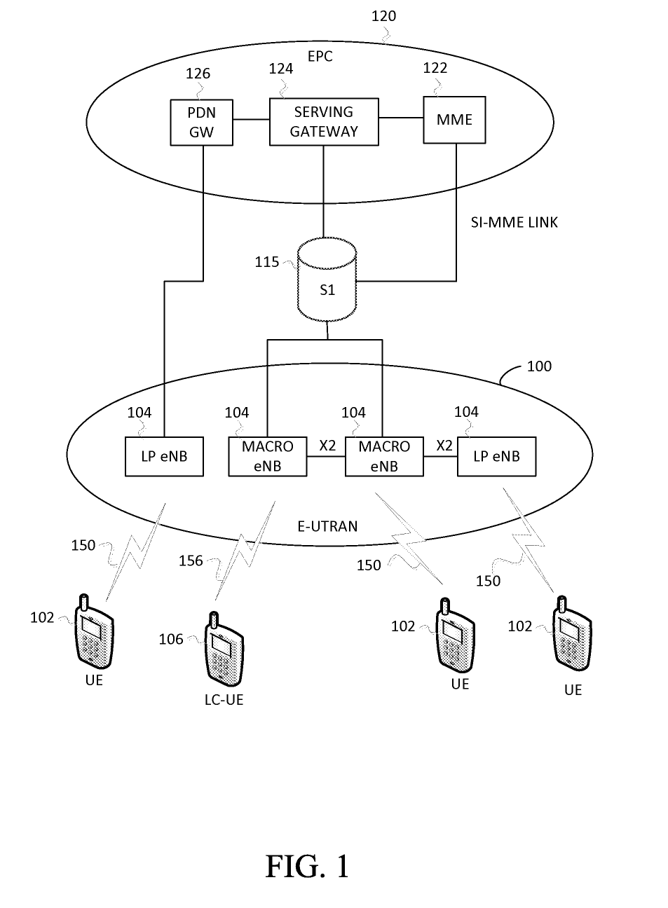

FIG. 1 shows a portion of an end-to-end network architecture of an Long-Term Evolution (LTE) network with various components of the network in accordance with some embodiments. LTE, as used herein, may refer to LTE as well as LTE-A networks. The network comprises a radio access network (RAN) 100, (e.g., as depicted, E-evolved universal terrestrial radio access network (E-UTRAN)) and the core network 120 (e.g., shown as an evolved packet core (EPC)) coupled together through an S1 interface 115. For convenience and brevity's sake, only a portion of the core network 120, the RAN 100, and the interfaces are shown.

The core network 120 includes mobility management entity (MME) 122, serving gateway (serving GW) 124, and packet data network gateway (PDN GW) 126. The RAN 100 includes enhanced node B's (eNBs) 104 (which may operate as base stations) for communicating with a UE 102. The eNBs 104 may include macro eNBs and low power (LP) eNBs. The UE 102 and eNBs 104 are transmitting and receiving communications 150. The LC-UE 106 and eNBs 104 are transmitting and receiving communications 156.

The MME 122 is similar in function to the control plane of legacy Serving GPRS Support Nodes (SGSN). The MME 122 manages mobility aspects in access such as gateway selection and tracking area list management. The serving GW 124 terminates the interface toward the RAN 100, and routes data packets between the RAN 100 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates an SGi interface toward the packet data network (PDN). The PDN GW 126 routes data packets between the core network 120 (an EPC network here) and the external PDN, and may be a key node for policy enforcement and charging data collection. It may also provide an anchor point for mobility with non-LTE accesses. The external PDN can be any kind of Internet Protocol (IP) network, as well as an IP Multimedia Subsystem (IMS) domain. The PDN GW 126 and the serving GW 124 may be implemented in one physical node or separated physical nodes.

The eNBs 104 (macro and micro) terminate the air interface protocol and may be the first point of contact for a UE 102 or LC-UE 106. In some embodiments, an eNB 104 may fulfill various logical functions for the RAN 100 including but not limited to RNC (radio network controller functions) such as radio bearer management, uplink and downlink dynamic radio resource management or control (RRC) and data packet scheduling, and mobility management. In some cases the RRC functions are handled by another part of the RAN 100. In accordance with embodiments, UEs 102 may be configured to communicate OFDM communication signals with an eNB 104 over a multicarrier communication channel in accordance with an OFDMA communication technique. The OFDM signals may comprise a plurality of orthogonal subcarriers.

The S1 interface 115 is the interface that separates the RAN 100 and the core network 120, which may be an EPC network. It is split into two parts: the S1-U, which carries traffic data between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB 104 might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB 104 can generally connect through the X2 link to another eNB 104 such as a macro eNB 104 through its base station controller (BSC) functionality. Thus, LP eNB 104 may be implemented with a picocell eNB 104 since it is coupled to a macro eNB 104 via an X2 interface. Picocell eNBs 104 or other LP eNBs 104 may incorporate some or all functionality of a macro eNB 104. In some cases, this may be referred to as an access point base station or enterprise femtocell.

In some embodiments, a downlink resource grid may be used for downlink transmissions from an eNB 104 to a UE 102 or LC-UE 106. The grid may be a time-frequency grid, called a resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements, and in the frequency domain, this represents the smallest quanta of resources that currently can be allocated. There are several different physical downlink channels that are conveyed using such resource blocks. Two of these physical downlink channels are the physical downlink shared channel and the physical downlink control channel.

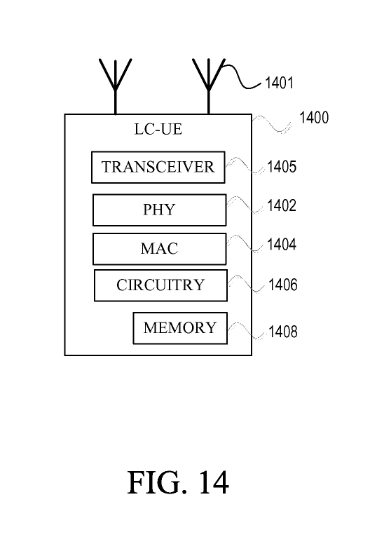

The LC-UE 106 may be a low complexity UE category 0, UE, or low cost UE. In example embodiments, the LC-UE 106 may have one antenna 1401 (see FIG. 14). The LC-UE 106 may be a machine-type communications (MTC) such as machine-to-machine (M2M) communications. MTC may be communications between machines over mobile networks that do not necessarily need human interaction. The LC-UE 106 may have a limited communication pattern in comparison to a UE 102 operated by a human operator. In some embodiments, LC-UEs 106 are targeted to low-end (e.g. low average revenue per user, low data rate, delay tolerant) applications, e.g. some MTC. A LC-UE 106 may have reduced transmit (Tx) and receive (Rx) capabilities compared with other UEs 102 of different categories. In example embodiments, the LC-UE 106 may have a limited downlink (DL) and/or uplink (UL) transport block size (TBS) of, for example, 1000 bits for unicast transmission.

The eNB 104 may not support LC-UEs 106. For example, some eNBs 104 in a public land mobile network (PLMN) may not support LC-UEs 106. If the cell and/or eNB 104 does not support LC-UEs 106, a LC-UE 106 may consider the cell as barred. The eNB 104 may include an indication of whether or not the eNB 104 supports LC-UEs 106. For example, the eNB 104 may include a System Information BlockType1 (SIB1), which may indicate that the eNB 104 supports LC-UEs 106. In example embodiments, the SIB1 may include a new information element (IE) that may be defined as “category0Allowed-r12,” which may be true or false to indicate whether category 0 UEs or LC-UEs 106 are supported. In example embodiments, a category 0 UE or LC UE 106 may access a cell only if the SIB1 message includes the “category0Allowed” IE.

In some embodiments, the eNB 104 determines that a UE 102 is a LC-UE 106 based on the logical channel identification (LCID) for common control channel (CCCH) and the UE 102 capability. In some embodiments, the S1 115 signaling has been extended to include the UE radio capability for paging. This paging specific capability information may be provided by the eNB 104 to the MME 122, and the MME 122 may use this information to indicate to the eNB 104 that the paging request from the MME 122 concerns a LC-UE 106.

The eNB 104 may vary support for LC-UE 106 during operation based on such things as cell load, prioritization of UEs 102, etc. The eNB 104 may determine which neighbor eNBs 104 support LC-UEs 106 to perform a connected mode handover for a LC-UE 106. The eNB 104 may determine which neighbor base stations support LC-UEs 106 to perform a handover for a LC-UE 106.

In some embodiments, the eNBs 104 and the UEs 102/LC-UE 106 may implement other radio technologies such as Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), IEEE 802.16, CDMA, etc. Although, a LTE network is illustrated, the EPC 120 and/or RAN 100 may be in communication with other types of networks such as a GERAN and UMTS.

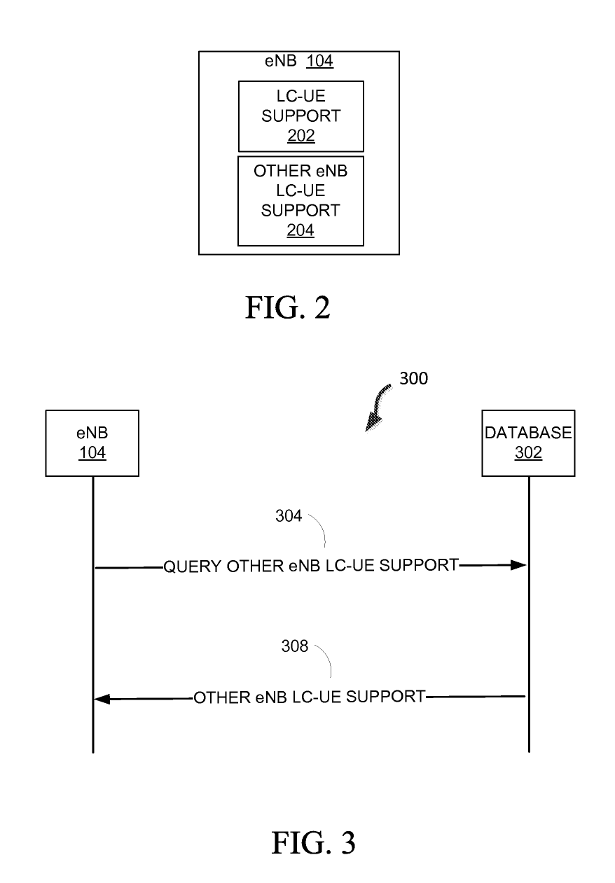

FIG. 2 illustrates an eNB 104 with information regarding LC-UE support in accordance with some embodiments. In example embodiments, the eNB 104 includes LC-UE support 202 and other eNBs LC-UE support 204. The LC-UE support 202 may indicate the support offered by the eNB 104 for LC-UEs 106. For example, the eNB 104 may include an information element in SIB1 which may indicate the LC-UE support 202 offered by the eNB 104. The other eNB LC-UE support 204 may be information that indicates the support offered by other eNBs 104 to LC-UEs 106 such as eNBs 104 that are neighbors to the eNBs 104.

In example embodiments, the eNB 104 may be pre-configured with other eNB LC-UE support 204. The eNB 104 may share LC-UE support 202 with neighboring eNBs 104 and base stations through an Operations, Administration, Maintenance (OAM) system or configuration. In example embodiments, the OAM may provide LC-UE support 202 and other eNB LC-UE support 204 to the eNBs 104. In example embodiments, the eNB 104 may get the other eNB LC-UE support 204 from an OAM configuration. The OAM system or configuration may be a database that is updated by the network. For example, operators of the network may insure that the OAM configuration is maintained and updated.

FIG. 3 illustrates a method 300 of an eNb 104 querying a database 302 for other eNB LC-UE support in accordance with some embodiments. The method 300 may begin at operation 304 with the eNB 104 sending a query of other eNB LC-UE support to the database 302. For example, the database 302 may store the other eNB LC-UE support 204 for eNBs 104. The eNB 104 may query the database 302 for other eNB LC-UE support 204. The database 302 may be self-optimizing network (SON). The database 302 may be updated for additions, modifications and deletions of eNBs 104.

Alternatively, a network operator may maintain a database (e.g. in OAM) of LC-UE support 202 for eNBs 104 in the network. The LC-UE support 202 and other eNB LC-UE support 204 may vary with time of day or other factors. The database 302 may perform a query and determine the other eNB LC-UE support 204. The method 300 may continue at operation 308 with the database 302 sending a response with other eNB LC-UE support 204.

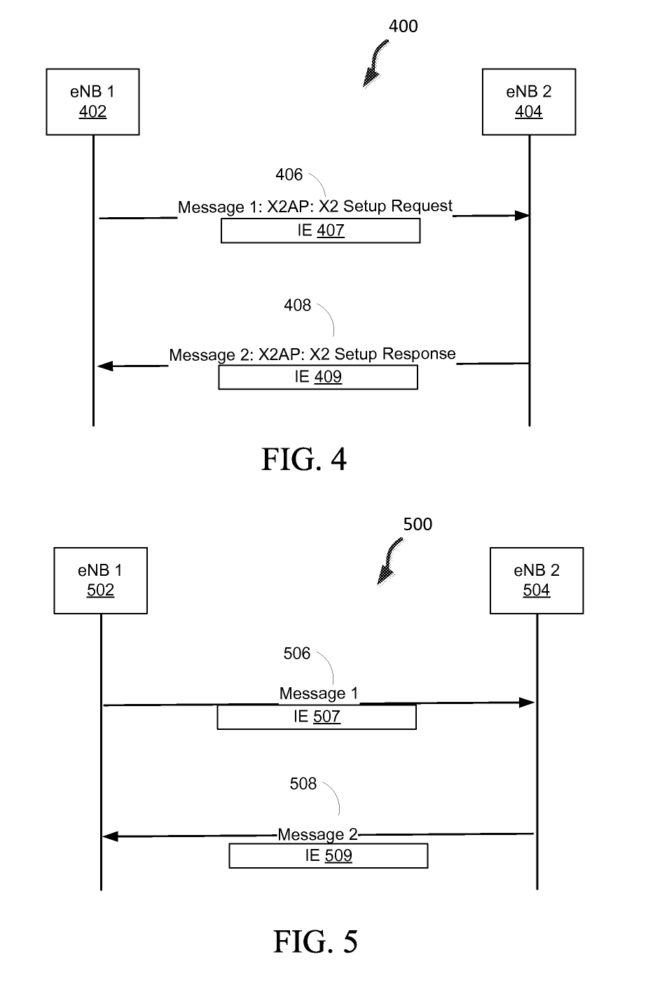

FIG. 4 illustrates a method 400 of determining support for LC-UEs where messages are exchanged in accordance with some embodiments. Illustrated in FIG. 4 are eNB 1 402, eNB 2 404, message 1 406, and message 2 408. The eNB 1 402 and eNB 2 404 may be eNBs 104. eNB 1 402 may be a source eNB 104 that intends to handover a LC-UE 106. eNB 2 404 may be a potential target eNB 104 that the eNB 1 302 may handover the LC-UE 106 too.

The method 400 may begin at operation 406 with eNB 1 402 sending message 1 406, which may be an X2 application protocol (X2AP): X2 Setup Request message, to eNB 2 404. Message 1 406 may, optionally, include an information element (IE) 407 that indicates the LC-UE support offered by eNB 1 402. For example, the IE 407 may include cellSupport-Category-0 field, which may indicate the LC-UE support offered by eNB 1 402. In example embodiments, message 1 406 may be another X2AP message used in an X2AP message exchange between two eNBs 104. In example embodiments, message 1 406 may be a S1 application protocol (S1AP) message used in an S1AP message exchange between eNBs 104.

The method 400 may continue at operation 408 with eNB 2 404 sending message 2 408, which may be an X2AP: X2 Setup Response message, to eNB 1 402. Message 2 408 may, optionally, include an information element (IE) 409 that indicates the LC-UE support offered by eNB 2 404. For example, the IE 409 may include cellSupport-Category-0 field, which may indicate the LC-UE support offered by eNB 2 404. In example embodiments, message 2 408 may be another X2AP message used in an X2AP message exchange between two eNBs 104. In example embodiments, message 2 408 may a S1AP message used in an S1AP message exchange between eNBs 104.

FIG. 5 illustrates a method of determining support for LC-UEs 106 where an eNB 104 requests LC-UE support information from another eNB 104 in accordance with some embodiments. Illustrated in FIG. 5 are eNB 1 502, eNB 2 504, message 1 506, and message 2 508. The eNB 1 502 and eNB 2 504 may be eNBs 104. eNB 1 502 may be a source eNB 104 that intends to handover a LC-UE 106. eNB 2 504 may be a potential target eNB 104 that the eNB 1 502 may handover the LC-UE 106 to.

The method 500 may begin at operation 506 with eNB 1 502 sending message 1 506 to eNB 2 504. Message 1 506 may include an information element with a request to the eNB 2 504 to report support information for LC-UEs 106. Message 1 506 may be a message from eNB 1 502 to eNB 504 in accordance with X2 or S1. The method 500 may continue with the eNB 2 504 responding with message 2 508. Message 2 508 may include an IE 409 that reports eNB 2 504 support information for LC-UEs, which may be reported in a cellSupport-Category-0 field.

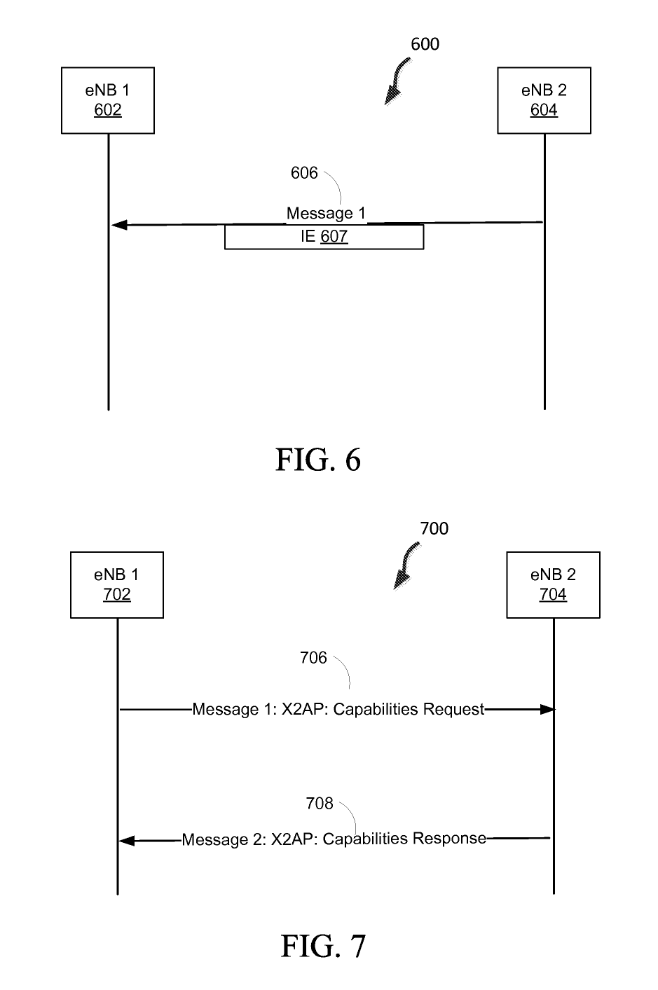

FIG. 6 illustrates a method 600 of determining support for LC-UEs 106 where an eNB 104 indicates support information for LC-UEs 106 in accordance with some embodiments. Illustrated in FIG. 6 are eNB 1 602, eNB 2 604, and message 1 606. eNB 1 602 and eNB 2 604 may be eNBs 104. eNB 1 602 may be a source eNB 104 that intends to handover a LC-UE 106. eNB 2 604 may be a potential target eNB 104 that the eNB 1 602 may handover the LC-UE 106 to. The method 600 may begin with eNB 2 604 sending message 1 606 to eNB 1 602 with an IE 607 that may indicate support information for LC-UEs 106 offered by eNB 2 604. The message 1 606 may be an eNB 104 configuration update message.

FIG. 7 illustrates a method 700 of determining support for LC-UE 106 where an eNB 104 requests LC-UE 106 support information from another eNB 104 in accordance with some embodiments. Illustrated in FIG. 7 are eNB 1 702, eNB 2 704, message 1 706, and message 2 708. The eNB 1 702 and eNB 2 704 may be eNBs 104. eNB 1 702 may be a source eNB 104 that intends to handover a LC-UE 106. eNB 2 704 may be a potential target eNB 104 that the eNB 1 702 may handover the LC-UE 106 too.

The method 700 may begin at operation 706 with eNB 1 502 sending message 1 706 to eNB 2 504. Message 1 706 may be an X2AP: capabilities request message that requests the capabilities of eNB 2 704 including the support of LC-UE support offered by the eNB 2 704. The eNB 2 704 may generate a response to message 1. The method 700 may continue at operation 708 with message 2: X2AP: capabilities response. The capabilities response message includes an indication of the support of LC-UEs offered by the eNB 2 704.

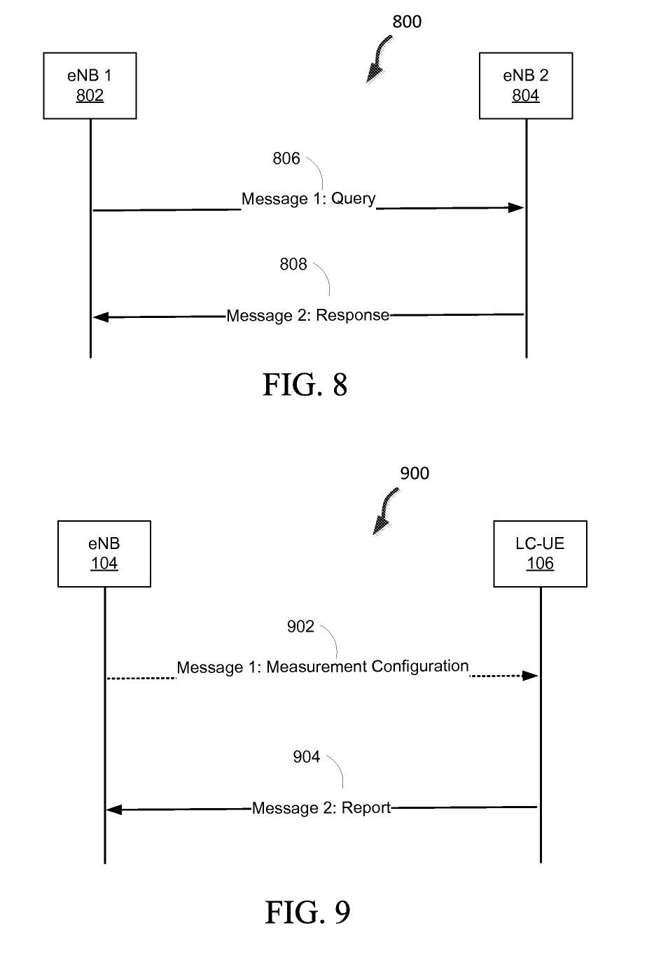

FIG. 8 illustrates a method 800 of determining support for LC-UEs 106 where an eNB 104 requests LC-UE 106 support information from another eNB 104 in accordance with some embodiments. Illustrated in FIG. 8 are eNB 1 802, eNB 2 804, message 1 806, and message 2 808. The eNB 1 802 and eNB 2 804 may be eNBs 104. eNB 1 802 may be a source eNB 104 that intends to handover a LC-UE 106. eNB 2 804 may be a potential target eNB 104 that the eNB 1 802 may handover the LC-UE 106 too.

The method 800 may begin at operation 806 with eNB 1 802 sending message 1 to eNB 2 804. Message 1 806 may be an X2 message that may be used to query a target eNB 2 804 of the LC-UE 106 support offered by the eNB 804. Message 1 806 may be a message for initiating a handover.

The method 800 may continue at operation 808 with eNB 2 804 sending message 2 to eNB 1 802. Message 2 808 may be an X2 message that may be used to respond to a query from a source eNB 1 802. Message 2 808 may be a message that is part of a handover protocol. In example embodiments, message 1 806 may include an IE that includes a request for support of LC-UE 106, and message 2 808 may include an IE that indicates the support for LC-UE 106. In example embodiments, message 1 806 may not be understood by eNB 2 804 (e.g., the protocol used by eNB 2 804 may not support message 1 806) so message 2 806 may be an error message indicating that eNB 2 804 does not understand message 1 806. For example, message 2 may be “ERROR INDICATION” in response to message 1 806.

FIG. 9 illustrates a method 900 of determining support for LC-UE in accordance with some embodiments. The method 900 may optionally begin at operation 902 with message 1: measurement configuration. The eNB 104 may send a measurement configuration to the LC-UE 106 that indicates that the LC-UE 106 should only perform measurement on some cells such as only dedicated eNBs 104 that are dedicated to MME/PGW/SGW. The measurement configuration may be a whitelist and/or blacklist that indicates that only eNBs 104 that are either part of the blacklist or the whitelist should be measured. In example embodiments, the whitelist and/or blacklist may indicate those eNBs 104 that support LC-UE 106 or that will allow the LC-UE 106 to associate with the eNB 104.

The method 900 may continue at operation 904 with message 2. The LC-UE 106 may send a measurement report to the eNB 104. The measurement report may only include eNBs 104 that support LC-UEs 106. The measurement report may be based on the measurement configuration 902 sent to the LC-UE 106 by the eNB 104. In example embodiments, the LC-UE 106 may know frequencies that support LC-UEs 106, and/or the LC-UE 106 may decode the SIB1 of a target eNB 104 during a measurement process.

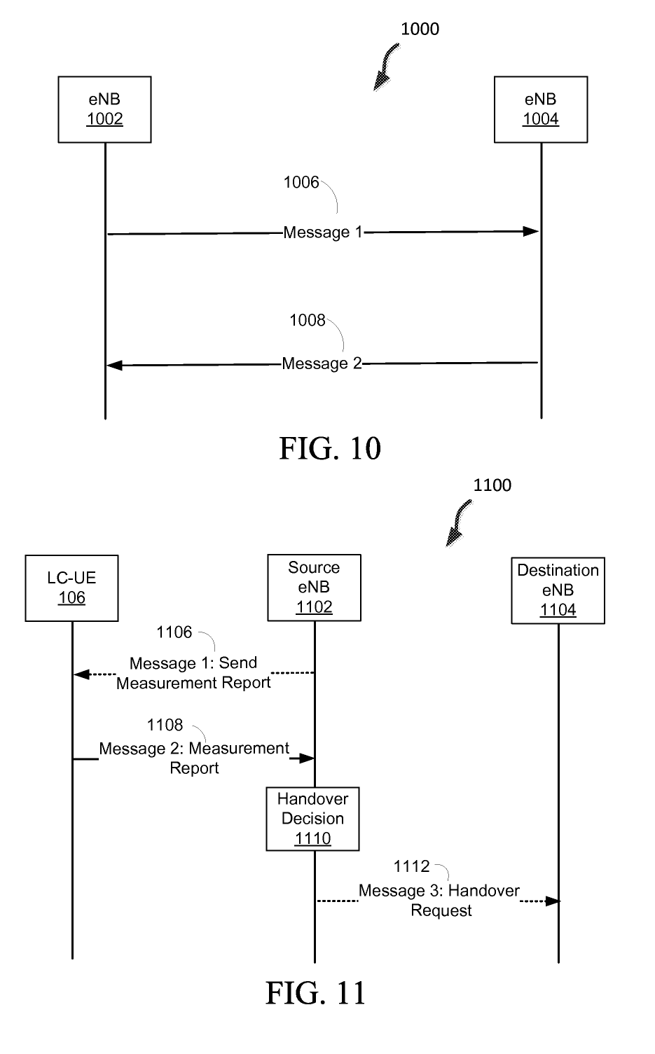

FIG. 10 illustrates a method 1000 of determining support for LC-UE in accordance with some embodiments. The method 1000 may begin at operation 1006 with a source eNB 1002 sending message 1 to a target eNB 1004. Message 1 may include a LC-UE 106 (or cat 0 UE) support indication. Message 1 may be an X2 AP or S1 AP handover preparation messages (e.g. HANDOVER REQUIRED, HANDOVER REQUEST or other messages) sent between source eNB 1002 and target eNB 1004.

The method 1000 continues at operation 1008 with the target eNB 1004 sending message 2. Message 2 may be a “HANDOVER FAILURE” message with an appropriate cause value, if the target eNB 1004 does not support LC-UE 106. An appropriate cause value may include “cat. 0 not supported”. The eNB 1004 may not support LC-UEs 106 due to operating with an older release that does not support LC-UEs 106. Message 2 may be a HandoverReqAck (confirming support for LC-UE 106). In example embodiments, if HandoverReqAck doesn't indicate support for LC-UE 106, then source eNB 1002 may initiate a handover cancellation. In example embodiments, message 1 1006 includes a new IE that is encoded so that target eNBs 1004 that do not support LC-UEs 106 rejects the IE and generate a message 2 that includes an “ERROR INDICATION”.

In example embodiments, target eNB 1004 may need to explicitly accept LC-UE 106 in order for the source eNB 1002 to continue with the handover process. Source eNB 1002 may be configured to “learn” which neighbor cells support LC-UE 106 based on a successful handover of a LC-UE 106 or an unsuccessful handover of a LC-UE 106. Learning which eNBs 1004 support LC-UEs 106 may save signaling for cases in which target 1004 eNB does not support LC-UEs 106.

FIG. 11 illustrates a method 1100 of determining whether to handover a LC-UE 106 to a destination eNB 1104 in accordance with some embodiments. The method 1100 may optionally begin at operation 1106 with the source eNB 1102 sending message 1 1106 to the LC-UE 106. Message 1 1006 may be a measurement control message. Message 1 1106 may indicate to the LC-UE 106 that it should take measurements of destination eNBs 1104. Message 1 1106 may include an indication of which eNBs 1104 to take measurements of. For example, message 1 1106 may include a list of eNBs 1104 that support LC-UE 106.

In example embodiments, the source eNB 1102 may determine whether it is necessary to send message 1: send measurement report 1106. In example embodiments, eNB 1102 maintains a list of LC-UEs 106 in its coverage. In example embodiments, source eNB 1102 may only send message 1 1106 to LC-UE 106 if the source eNB 1102 cannot determine a suitable destination eNB 1104 to handover LC-UE 106 to.

The method 1100 may continue at operation 1108 with LC-UE 106 sending message 2: measurement report 1108 to source eNB 1102. The measurement report may include information for what type of services the LC-UE 106 is requesting such as emergency or high priority. The measurement report may include information regarding whether or not the LC-UE 106 is permitted to attach to eNBs 106 that do not support eNBs 106.

The method 1100 continues at operation 1110 with the source eNB 1102 determining a handover decision. The source eNB 1102 may determine to handover the LC-UE 106 that does not support LC-UE 106 based on the type of service the LC-UE 106 is seeking and/or whether the LC-UE 106 indicates that it can attach to eNBs 1104 that do not support LC-UE 106.

The source eNB 1102 may determine to handover the LC-UE 106 to a destination eNB 1104 that does not support LC-UE 106 completely but that may support camping. If the LC-UE 106 is configured with power-saving mechanism (PSM), the source eNB 1102 may determine to not turn over the LC-UE 106 if there is no suitable destination eNB 1104. The source eNB 1102 may send a message to the LC-UE 106 indicating that there is no suitable destination eNB 1104. The LC-UE 106 may save power in this way by not continuing to take measurements.

The method 1100 may optionally continue at operation 1112 with the source eNB 1102 sending message 3: handover request. The eNB 1102 may send a handover request to a destination eNB 1104 that the source eNB 1102 has determined to attempt to handover the LC-UE 106 to.

In example embodiments, S1-based handover procedures may be used when X2-based handover cannot be used. For example, the eNBs 104 may not be connected so that they cannot use the X2 interface. The methods described herein may be used with the S1 interface where the MME may access the information of eNBs during the S1-AP setup procedures or via OAM.

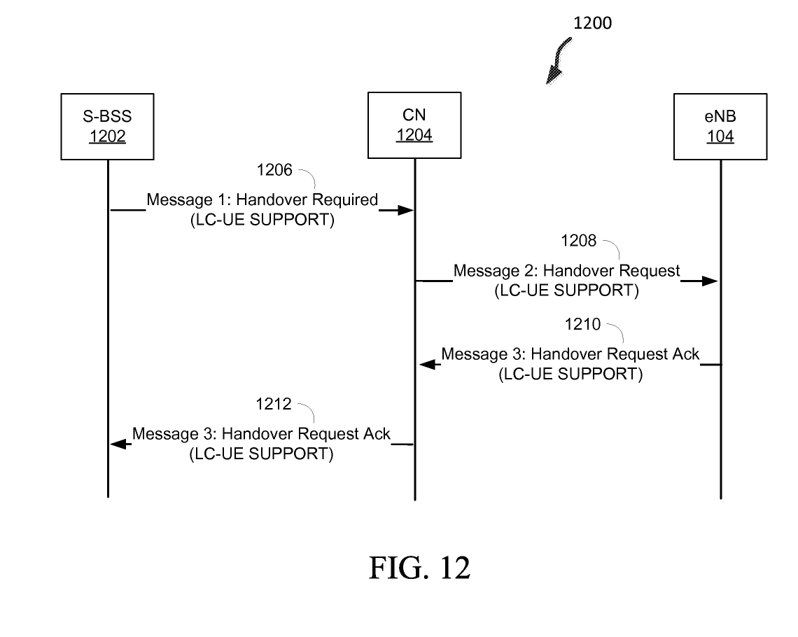

FIG. 12 illustrates a method 1200 of an inter-RAT handover of a LC-UE 106 to a target eNB 104 in accordance with some embodiments. A LC-UE 106 (not illustrated in FIG. 12) may be attached to a non-LTE network such as GERAN. For example, as illustrated, the LC-UE 106 may be attached to an source base station subsystem (S-BSS) 1202. The method 1200 may begin at operation 1206 with the S-BSS 1202 sending message 1: handover required to CN 1204. The S-BSS 1202 may determine that a handover of the LC-UE 106 is required. The CN 1204 may be a core network such as an EPC 120 illustrated in FIG. 1. Message 1 1206 may include an indication that LC-UE support is needed for the target eNB 104. The indication may be included in message 1 1206 as part of the type of message that message 1 1206 is and/or with an information element that indicates that the target eNB 104 needs to support LC-UE. Message 1 1206 may indicate that the S-BSS 1202 is requesting that a support IE for LC-UE 106 be returned to the S-BSS 1202. The handover decision may have been made by the CN 1204 based on LTE measurements received from the LC-UE 106. There may be no direct connection between the S-BSS 1202 and the eNB 104.

The method 1200 may continue at operation 1208 with the CN 1204 sending message 2: handover request to the eNB 104. Message 2 1208 may include an IE that indicates the CN 1204 is requesting LC-UE 106 support information. Message 2 1208 may indicate the CN 1204 is requesting support information based on the type of message.

The method 1200 may continue at operation 1210 with the eNB 104 sending message 3: handover request Ack to the CN 1204. Message 3 may include an indication of LC-UE 106 support of the eNB 104. The LC-UE 106 support may be indicated with an IE, or the type of message of message 3. For example, message 3 may be a refusal of a handover to indicate that eNB 104 does not support LC-UE 106.

The method 1200 may continue at operation 1212 with the CN 1204 sending message 3: handover request Ack to the S-BSS 1202. Message 3 1212 may indicate that the handover can be done and may include information regarding the LC-UE support of the eNB 104. The CN 1204 may determine that the handover cannot be performed based on message 3 1210 and send a handover cancel message to the S-BSS 1202.

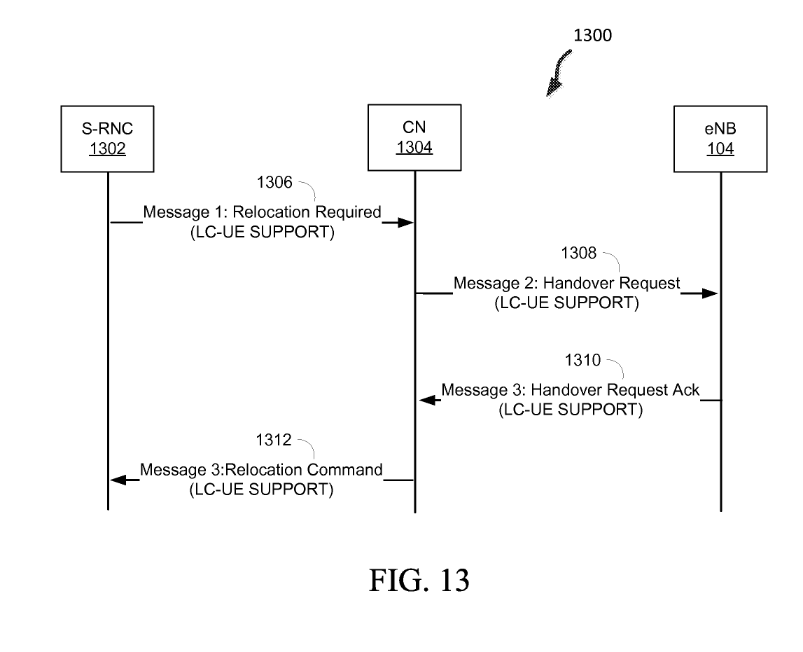

FIG. 13 illustrates a method 1300 of an inter-RAT handover of a LC-UE 106 to a target eNB 104 in accordance with some embodiments. A LC-UE 106 (see FIG. 1) may be attached to a non-LTE network such as UMTS. For example, as illustrated, the LC-UE 106 may be attached to an S-RNC 1202. The method 1300 may begin at operation 1306 with the S-RNC 1302 sending message 1: relocation required to CN 1304. The S-RNC 1302 may determine that a handover of the LC-UE 106 is required. The CN 1304 may be a core network such as the EPC 120 as illustrated in FIG. 1. Message 1 1306 may include an indication that LC-UE support is needed for the target eNB 104. The indication may be included in message 1 1306 as part of the type of message that message 1 1306 is and/or with an information element that indicates that the target eNB 104 needs to support LC-UE Support. Message 1 1306 may indicate that the S-RNC 1302 is requesting that a support IE for LC-UE 106 be returned to the S-RNC 1302. The handover decision may have been made by the CN 1204 based on LTE measurements received from the LC-UE 106. There may be no direct connection between the S-RNC 1302 and the eNB 104.

The method 1300 may continue at operation 1308 with the CN 1304 sending message 2: handover request to the eNB 104. Message 2 1308 may include an IE that indicates the CN 1304 is requesting LC-UE 106 support information. Message 2 1308 may indicate the CN 1304 is requesting support information based on the type of message.

The method 1300 may continue at operation 1310 with the eNB 104 sending message 3: handover request Ack to the CN 1304. Message 3 may include an indication of LC-UE 106 support of the eNB 104. The LC-UE 106 support may be indicated with an IE, or the type of message of message 3 1310. For example, message 3 1310 may be a refusal of a handover to indicate that eNB 104 does not support LC-UE 106.

The method 1300 may continue at operation 1312 with the CN 1304 sending message 3: relocation command to the S-RNC 1302. Message 3 1312 may indicate that the handover can be done and may include information regarding the LC-UE support of the eNB 104. The CN 1304 may determine that the handover cannot be performed based on message 3 1312 and send a handover cancel message (not illustrated) to the S-RNC 1302.

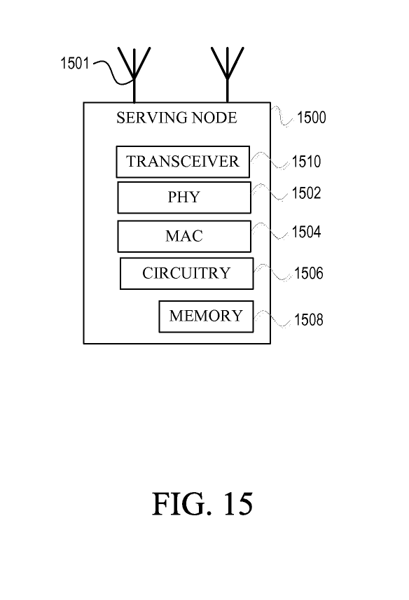

FIG. 14 shows a block diagram of a UE 1400 in accordance with some embodiments. FIG. 15 shows a block diagram of an eNB 1500 in accordance with some embodiments. It should be noted that in some embodiments, the eNB 1500 may be a stationary non-mobile device. The UE 1400 may be a LC-UE 106 as depicted in FIG. 1, while the eNB 1500 may be an eNB 104 as depicted in FIG. 1. The LC-UE 1400 may include physical layer circuitry (PHY) 1402 for transmitting and receiving signals to and from the eNB 1500, other eNBs, UEs, other LC-UEs or other devices using one or more antennas 1401, while the eNB 1500 may include physical layer circuitry (PHY) 1502 for transmitting and receiving signals to and from the UE 1400, other eNBs, BSSs, RNCs, base stations, other UEs or other devices using one or more antennas 1401. The LC-UE 1400 may also include medium access control layer (MAC) circuitry 1404 for controlling access to the wireless medium, while the eNB 1500 may also include medium access control layer (MAC) circuitry 1504 for controlling access to the wireless medium. The LC-UE 1400 may also include processing circuitry (circuitry) 1406 and memory 1408 arranged to perform the operations described herein in conjunction with FIGS. 1-13, and the eNB 1500 may also include processing circuitry (circuitry) 1506 and memory 1508 arranged to perform the operations described herein in conjunction with FIGS. 1-13. The LC-UE 1400 may include a transceiver 1405 for controlling the antenna 1401, while the eNB 1500 may include a transceiver 1510 for controlling the antenna 1401.

The antennas 1401, 1501 may comprise one or more directional or omnidirectional antennas, including, for example, dipole antennas, monopole antennas, patch antennas, loop antennas, microstrip antennas or other types of antennas suitable for transmission of RF signals. In some multi-user multiple-input multiple-output (MU-MIMO) embodiments, the antennas 1401, 1501 may be effectively separated to take advantage of spatial diversity and the different channel characteristics that may result.

Although the LC-UE 1400 and eNB 1500 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, the LC-UE 1400 may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, or wearable device etc.), or other device that may receive and/or transmit information wirelessly. In some embodiments, the UE 800 may include one or more of a keyboard, a display, a non-volatile memory port, multiple antennas, a graphics processor, an application processor, speakers, and other mobile device elements. The display may be an LCD screen including a touch screen.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

In accordance with embodiments, the LC-UE 1400 and eNodeB 1500 may be configured for one or more of the example embodiments described herein in conjunction with FIGS. 1-13 such as providing support for LC-UE 1400.

The following examples pertain to further embodiments. Example 1 is a wireless communication device. The wireless communication device may include circuitry configured to: determine support of a target evolved nodeB (eNB) for a low complexity user equipment (LC-UE); and handover the LC-UE to the target eNB if the support of the target eNB indicates the target eNB supports LC-UE.

In Example 2, the subject matter of Example 1 can optionally include where the wireless communication device is one from the following group: a long term evolution (LTE) wireless communication device and an advanced LTE (LTE-A).

In Example 3, the subject matter of Examples 1 or 2 can optionally include where the LC-UE device is configured according to at least one of the following group: to communicate with a limited downlink (DL) block size and a limited uplink (UL) block size; and, to communicate with reduced transmit and receive capabilities compared with other user equipment.

In Example 4, the subject matter of any of Examples 1-3 can optionally include where the wireless communication device is one from the following group: a source eNB, a core network entity, an LC-UE, a source radio network controller (RNC), a base station, a source base service set (BSS), a dedicated network node for LC-UE, and an eNB dedicated for LC-UE.

In Example 5, the subject matter of any of Examples 1-4 can optionally include where the circuitry is configured to determine support of the target eNB for the LC-UE based on configuration information.

In Example 6, the subject matter of any of Examples 1-5 can optionally include where the circuitry is further configured to use an Operations, Administration, Maintenance (OAM) system to obtain the configuration information.

In Example 7, the subject matter of any of Examples 1-6 can optionally include where the circuitry is configured to determine support of the target eNB for the LC-UE based on a query to a database stored in at least one from the following group: a core network and the radio access network.

In Example 8, the subject matter of any of Examples 1-7 can optionally include where the circuitry is configured to determine support of the target eNB for the LC-UE based on an information element (IE) received from the target eNB.

In Example 9, the subject matter of any of Examples 1-8 can optionally include where the circuitry is configured to determine support of the target eNB for the LC-UE based on an information message received from the target eNB, the information message to include supported capabilities of the target eNB.

In Example 10, the subject matter of any of Examples 1-9 can optionally include where the circuitry is configured to determine support of the target eNB for the LC-UE based on a response to a query to the target eNB of support for LC-UEs.

In Example 11, the subject matter of any of Examples 1-10 can optionally include where the circuitry is configured to determine support of the target eNB for the LC-UE based on a selective measurement report generated by the LC-UE.

In Example 12, the subject matter of any of Examples 1-11 can optionally include where the circuitry is configured to determine support of the target eNB for the LC-UE based on a query to a core network entity.

In Example 13, the subject matter of any of Examples 1-12 can optionally include where the core network entity is to query the target eNB, and the core network entity sends an indication of the support of the target eNB to the wireless communication device.

In Example 14, the subject matter of any of Examples 1-13 can optionally include where the circuitry is configured to determine support of the target eNB for the LC-UE based on a response to a handover request.

In Example 15, the subject matter of any of Examples 1-14 can optionally include where the LC-UE is a category 0 user equipment.

In Example 16, the subject matter of any of Examples 1-16 can optionally include memory and a transceiver coupled to the circuitry.

In Example 17, the subject matter of Example 16 can optionally include one or more antennas coupled to the transceiver.

In Example 18 is a method on a wireless communication device. The method may include sending a handover request to a target evolved nodeB (eNB); determining support of the eNB for a low complexity user equipment (LC-UE); and handing over the LC-UE to the target eNB if the support of the target eNB indicates the target eNB supports LC-UE, if the target eNB supports LC-UE.

In Example 19, the subject matter of Example 18 can optionally include where the wireless communication device is one from the following group: a source eNB, a core network entity, a LC-UE, category 0 user equipment, a source radio network controller (RNC), a base station, a source base service set (BSS).

In Example 20, the subject matter of Examples 18 or 19 can optionally include where the LC-UE has reduced transmit and receive capabilities compared with other user equipment, and wherein the wireless communication device is one from the following group: a long term evolution (LTE) wireless communication device and an advanced LTE (LTE-A).

Example 21 is a low-complexity user equipment (LC-UE). The LC-UE may include circuitry configured to: receive an indication of which target evolved nodeBs (eNBs) offer support for LC-UEs; measure signals from one or more target eNBs based on the received indication of which eNBs offer support for LC-UEs; and send a report of the measured signals to a source eNB.

In Example 22, the subject matter of Example 21 can optionally include where the circuitry is further configured to measure signals from one or more target eNB based on the received indication of which eNBs offer support for LC-UEs, if signals from a source eNB indicate the LC-UE may need to hand over to one of the one or more target eNBs.

In Example 23, the subject matter of Examples 21 or 22 can optionally include memory and a transceiver coupled to the circuitry; and one or more antennas coupled to the transceiver.

Example 24 is a non-transitory computer-readable storage medium that stores instructions for execution by one or more processors to perform operations. The instructions are to configure the one or more processors to cause the wireless communication device to: determine support of a target evolved nodeB (eNB) for a low complexity user equipment (LC-UE), and handover the LC-UE to the target eNB if the support of the target eNB indicates the target eNB supports LC-UE.

In Example 25, the subject matter of Example 24 can optionally include where the instructions are further to configure the one or more processors to cause the wireless communication device to determine support of the target eNB for the LC-UE based on an information element (IE) received from the target eNB.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device, the wireless communication device comprising circuitry configured to:
determine support of a target evolved nodeB (eNB) for a low complexity user equipment (LC-UE); and
handover the LC-UE to the target eNB if the support of the target eNB indicates the target eNB supports LC-UE.

2. The wireless communication device of claim 1, wherein the wireless communication device is one from the following group: a long term evolution (LTE) wireless communication device and an advanced LTE (LTE-A).

3. The wireless communication device of claim 1, wherein the LC-UE device is configured according to at least one of the following group: to communicate with a limited downlink (DL) block size and a limited uplink (UL) block size; and, to communicate with reduced transmit and receive capabilities compared with other user equipment.

4. The wireless communication device of claim 1, wherein the wireless communication device is one from the following group: a source eNB, a core network entity, an LC-UE, a source radio network controller (RNC), a base station, a source base station subsystem, base service set, a dedicated network node for LC-UE, and an eNB dedicated for LC-UE.

5. The wireless communication device of claim 1, wherein the circuitry is configured to determine support of the target eNB for the LC-UE based on configuration information.

6. The wireless communication device of claim 5, wherein the circuitry is further configured to use an Operations, Administration, Maintenance (OAM) system to obtain the configuration information.

7. The wireless communication device of claim 1, wherein the circuitry is configured to determine support of the target eNB for the LC-UE based on a query to a database stored in at least one from the following group: a core network and the radio access network.

8. The wireless communication device of claim 1, wherein the circuitry is configured to determine support of the target eNB for the LC-UE based on an information element (IE) received from the target eNB.

9. The wireless communication device of claim 1, wherein the circuitry is configured to determine support of the target eNB for the LC-UE based on an information message received from the target eNB, the information message to include supported capabilities of the target eNB.

10. The wireless communication device of claim 1, wherein the circuitry is configured to determine support of the target eNB for the LC-UE based on a response to a query to the target eNB of support for LC-UEs.

11. The wireless communication device of claim 1, wherein the circuitry is configured to determine support of the target eNB for the LC-UE based on a selective measurement report generated by the LC-UE.

12. The wireless communication device of claim 1, wherein the circuitry is configured to determine support of the target eNB for the LC-UE based on a query to a core network entity.

13. The wireless communications device of claim 12, wherein the core network entity is to query the target eNB, and the core network entity sends an indication of the support of the target eNB to the wireless communication device.

14. The wireless communication device of claim 1, wherein the circuitry is configured to determine support of the target eNB for the LC-UE based on a response to a handover request.

15. The wireless communication device of claim 1, wherein the LC-UE is a category 0 user equipment.

16. The wireless communication device of claim 1, further comprising memory and a transceiver coupled to the circuitry.

17. The wireless communication device of claim 16, further comprising one or more antennas coupled to the transceiver.

18. A method on a wireless communication device, the method comprising:
sending a handover request to a target evolved nodeB (eNB);
determining support of the eNB for a low complexity user equipment (LC-UE); and
handing over the LC-UE to the target eNB if the support of the target eNB indicates the target eNB supports LC-UE, if the target eNB supports LC-UE.

19. The method of claim 18, wherein the wireless communication device is one from the following group: a source eNB, a core network entity, a LC-UE, category 0 user equipment, a source radio network controller (RNC), a base station, a source base service set (BSS).

20. The method of claim 18, wherein the LC-UE has reduced transmit and receive capabilities compared with other user equipment, and wherein the wireless communication device is one from the following group: a long term evolution (LTE) wireless communication device and an advanced LTE (LTE-A).

21. A low-complexity user equipment (LC-UE), the LC-UE comprising circuitry configured to:
receive an indication of which target evolved nodeBs (eNBs) offer support for LC-UEs;
measure signals from one or more target eNBs based on the received indication of which eNBs offer support for LC-UEs; and
send a report of the measured signals to a source eNB.

22. The LC-UE of claim 21, wherein the circuitry is further configured to measure signals from one or more target eNB based on the received indication of which eNBs offer support for LC-UEs, if signals from a source eNB indicate the LC-UE may need to hand over to one of the one or more target eNBs.

23. The LC-UE of claim 21, further comprising memory and a transceiver coupled to the circuitry; and one or more antennas coupled to the transceiver.

24. A non-transitory computer-readable storage medium that stores instructions for execution by one or more processors to perform operations, the instructions to configure the one or more processors to cause the wireless communication device to:
determine support of a target evolved nodeB (eNB) for a low complexity user equipment (LC-UE); and
handover the LC-UE to the target eNB if the support of the target eNB indicates the target eNB supports LC-UE.

25. The non-transitory computer-readable storage medium of claim 24, wherein the instructions are further to configure the one or more processors to cause the wireless communication device to determine support of the target eNB for the LC-UE based on an information element (IE) received from the target eNB.
